(19) United States
(12) Patent Application Publication
(10) Pub. No.: US 2015/0002436 A1
(43) Pub. Date: Jan. 1, 2015

(54) INFORMATION PROCESSING APPARATUS, METHOD, AND NON-TRANSITORY COMPUTER-READABLE MEDIUM

(71) Applicant: SONY CORPORATION, Minato-ku, Tokyo (JP)

(72) Inventors: Akane Yano, Tokyo (JP); Lyo Takaoka, Tokyo (JP); Daisuke Hiro, Kanagawa (JP); Tomoya Narita, Kanagawa (JP)

(73) Assignee: SONY CORPORATION, Minato-ku, Tokyo (JP)

(21) Appl. No.: 14/379,926

(22) PCT Filed: Mar. 1, 2013
(86) PCT No.: PCT/JP13/01278

§ 371 Date: Aug. 20, 2014

(30) Foreign Application Priority Data
Mar. 15, 2012 (JP) 2012-058064

(51) Int. Cl. G06F 3/041; G06F 3/0482; G06F 3/0488; G06F 3/0481

(52) U.S. Cl. CPC G06F 3/0416; G06F 3/04817; G06F 3/0482; G06F 3/0488
USPC 345/173

(57) ABSTRACT

An information processing apparatus that controls a display to display first image data; acquires sensor output corresponding to a touch input received at the display; and controls the display to display second image data based on a duration and distance corresponding to the touch input.

### TECHNICAL FIELD

The present technology relates to a display controlling apparatus. More particularly, the present technology relates to a display controlling apparatus and a display controlling method for displaying an image and a program for causing a computer to execute the method.

### BACKGROUND ART

Electronic apparatus having a plurality of functions such as portable telephone sets and digital still cameras are widely used. Further, electronic apparatus are available wherein a menu screen image on which a user carries out various operations for executing a desired function is displayed on a touch panel such that a function is carried out in accordance with an operation input of the touch panel.

For example, a display controlling apparatus has been proposed wherein an icon is displayed in a size which increases as the distance from a reference point increases (refer to, for example, PTL 1).

### CITATION LIST

### Patent Literature

PTL 1: JP 2009-265793A

### SUMMARY

### Technical Problem

In the display controlling apparatus disclosed in the document mentioned above, since an icon is displayed in a size in response to a contact area of a fingertip with the display face of the display apparatus, operations in error can be reduced.

Incidentally, in the case where an electronic apparatus having a plurality of functions is operated, it is supposed that a large number of items as an operation target are displayed on the display screen image. In this instance, it seems a possible idea to switchably display an overhead view screen image on which the target of image display is looked down and an enlarged screen image on which part of the overhead view screen image is displayed in an enlarged scale. In the case where an overhead view screen image and a partial enlarged screen image are displayed switchably, it is important for the user to easily recognize a relationship between them.

The present technology has been created taking such a situation as described above into consideration, and it is an object of the present technology to make it possible to easily grasp, when a plurality of screen images are displayed switchably, a relationship between the screen images.

### Solution to Problem

An information processing apparatus that controls a display to display first image data; acquires sensor output corresponding to a touch input received at the display; and controls the display to display second image data based on a duration and distance corresponding to the touch input.

The circuitry may be configured to calculate a value corresponding to the duration and distance corresponding to the touch input; compare the calculated value to a predetermined threshold value; and control the display to display the second image data based on the comparison.

The circuitry may be configured to calculate the value by multiplying a first value corresponding to the duration of the touch input with a second value corresponding to the distance of the touch input; and compare the calculated value to a first threshold value and control the display to display the first image data as the second image data when the calculated value is less than the first threshold value.

The circuitry may be configured to compare the calculated value with a second threshold value when the calculated value is greater than or equal to the first threshold value; and control the display to display image data neighboring the first image data as the second image data when the calculated value is less than the second threshold value.

The circuitry may be configured to compare the calculated value with a third threshold value when the calculated value is greater than or equal to the second threshold value; and control the display to display the first image data and first neighboring image data corresponding to a first area neighboring the first image data as the second image data when the calculated value is less than the third threshold value.

The circuitry may be configured to control the display to display the first image data, the first neighboring image data corresponding to the first area neighboring the first image data and second neighboring image data corresponding to a second area neighboring the first area as the second image data when the calculated value is greater than or equal to the third threshold value.

The first image data may correspond to a first hierarchical item in a menu structure, and the circuitry may be configured to compare the calculated value to a first threshold value and control the display to display the first hierarchical item as the second image data when the calculated value is less than the first threshold value.

A non-transitory computer-readable medium including computer program instructions, which when executed by an information processing apparatus, cause the information processing apparatus to perform a process comprising: controlling a display to display first image data; acquiring a sensor output corresponding to a touch input received at the display; and controlling the display to display second image data based on a duration and distance corresponding to the touch input.

A method performed by an information processing apparatus, the method comprising: controlling a display to display first image data; acquiring a sensor output corresponding to a touch input received at the display; and controlling, by circuitry of the information processing apparatus, the display to display second image data based on a duration and distance corresponding to the touch input.

### Advantageous Effects of Invention

With the present technology, a superior advantage can be achieved that, when a plurality of screen images are displayed switchably, a relationship between the screen images can be recognized readily.

### BRIEF DESCRIPTION OF DRAWINGS

FIG. 1 is perspective views showing an example of an outer appearance configuration of a display controlling apparatus 100 according to a first embodiment of the present technology.

FIG. 2 is a block diagram showing an example of a functional configuration of the display controlling apparatus 100 according to the first embodiment of the present technology.

FIG. 3 is a view showing an example of a display screen image (menu screen image 300) displayed on an inputting/outputting section 150 according to the first embodiment of the present technology.

FIG. 4 is a view showing an example of a display screen image (menu screen image 400) displayed on the inputting/outputting section 150 according to the first embodiment of the present technology.

FIG. 5 is views illustrating an example of transition of a display screen image displayed on the inputting/outputting section 150 according to the first embodiment of the present technology.

FIG. 6 is views illustrating another example of transition of a display screen image displayed on the inputting/outputting section 150 according to the first embodiment of the present technology.

FIG. 7 is views illustrating a further example of transition of a display screen image displayed on the inputting/outputting section 150 according to the first embodiment of the present technology.

FIG. 8 is views illustrating a still further example of transition of a display screen image displayed on the inputting/outputting section 150 according to the first embodiment of the present technology.

FIG. 9 is views illustrating a yet further example of transition of a display screen image displayed on the inputting/outputting section 150 according to the first embodiment of the present technology.

FIG. 10 is views illustrating a yet further example of transition of a display screen image displayed on the inputting/outputting section 150 according to the first embodiment of the present technology.

FIG. 11 is a flow chart illustrating an example of a processing procedure of a display controlling process by the display controlling apparatus 100 according to the first embodiment of the present technology.

FIG. 12 is a flow chart illustrating an example of the processing procedure of the display controlling process by the display controlling apparatus 100 according to the first embodiment of the present technology.

FIG. 13 is views illustrating an example of transition of a display screen image displayed on an inputting/outputting section 150 according to a second embodiment of the present technology.

### DESCRIPTION OF EMBODIMENTS

In the following, modes (hereinafter referred to as embodiments) for carrying out the present technology are described. The description is given in the following order.

1. First Embodiment (display control: example wherein a display screen image formed in a hierarchical structure of two hierarchies is displayed)

2. Second Embodiment (display control: example wherein a display screen image formed in a hierarchical structure of three hierarchies is displayed)

3. Third Embodiment (display control: example wherein various criteria are used)

### 1. First Embodiment

“Example of Outer Appearance Configuration of Display Controlling Apparatus”

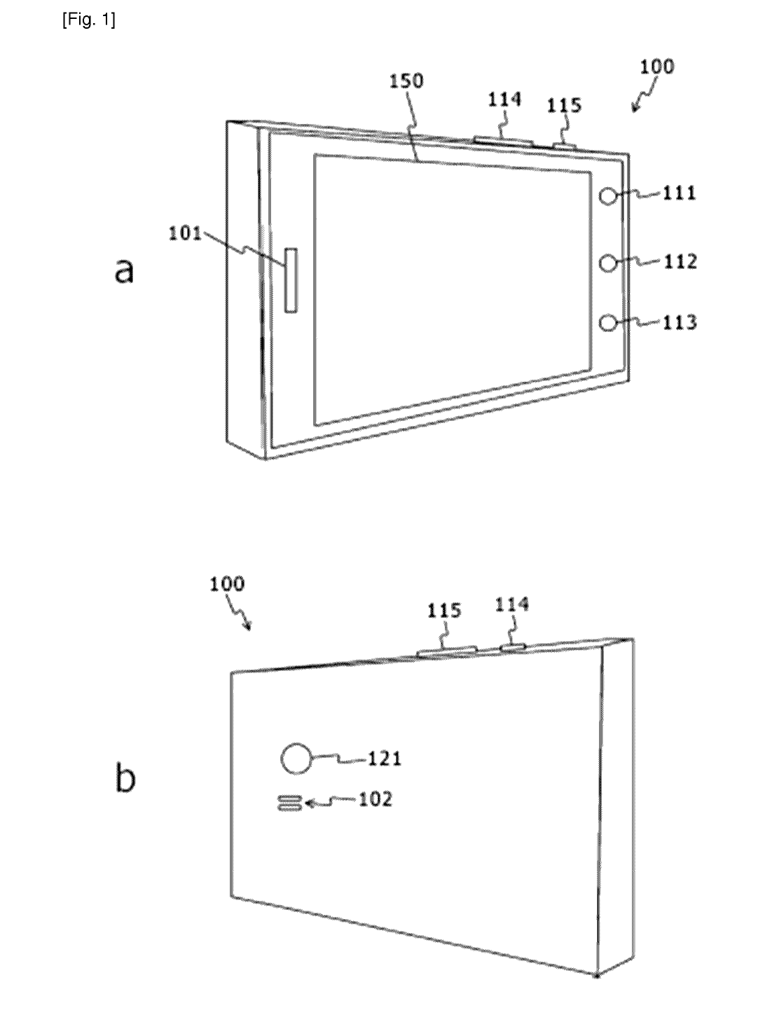

FIG. 1 are perspective views showing an example of an outer appearance configuration of a display controlling apparatus 100 according to a first embodiment of the present technology. In a of FIG. 1, an appearance of the display controlling apparatus 100 on one face side (in particular, on a face side on which an inputting/outputting section 150 is provided). Meanwhile, b of FIG. 1 shows an appearance of the display controlling apparatus 100 on another face side (in particular, on a side on which a lens 121 is provided).

The display controlling apparatus 100 includes first to fifth buttons 111 to 115, speakers 101 and 102, a lens 121, and an inputting/outputting section 150. The display controlling apparatus 100 is implemented, for example, by a wireless communication apparatus which can display various images thereon (for example, a portable telephone apparatus or a smartphone having a call function and a data communication function). It is to be noted that, while it is possible to provide other operation members on the display controlling apparatus 100, disclosure and description of them are omitted herein.

The first to fifth buttons 111 to 115 are operation members for carrying out various operations of the display controlling apparatus 100.

The speakers 101 and 102 are speakers which output various kinds of sound information therefrom. For example, the speaker 101 is a speaker used for telephone conversation while the speaker 102 is a speaker used for reproduction of content and so forth.

The lens 121 is a lens which condenses light from an imaging object.

The inputting/outputting section 150 displays various images thereon and accepts an operation input from a user based on a detection state of an object positioned in the proximity of or in contact with the display face thereof. It is to be noted that the inputting/outputting section 150 is also called a touch screen or a touch panel.

“Example of Functional Configuration of Display Controlling Apparatus”

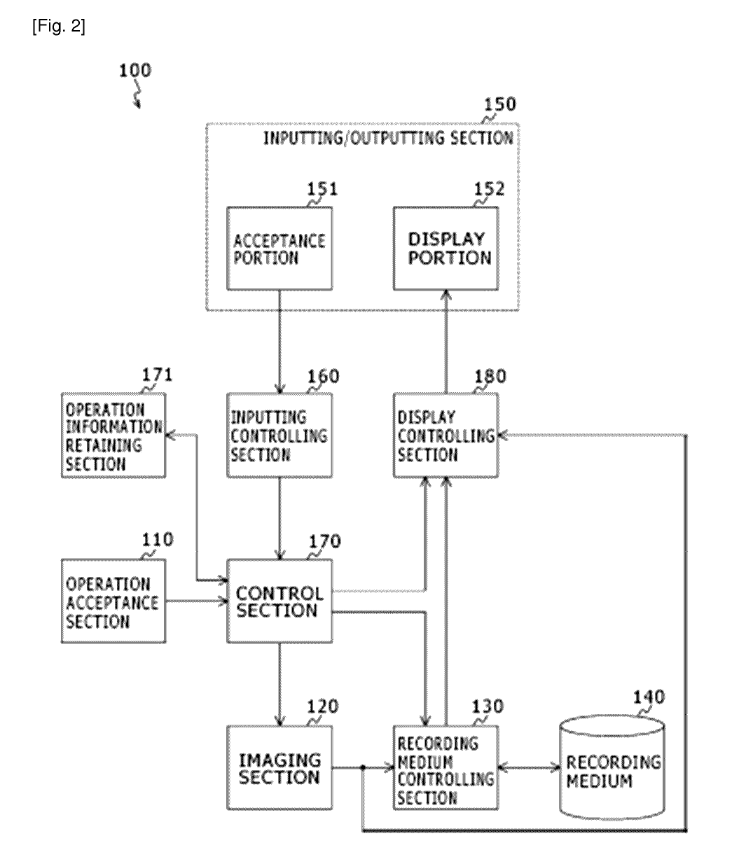

FIG. 2 is a block diagram showing an example of a functional configuration of the display controlling apparatus 100 according to the first embodiment of the present technology.

The display controlling apparatus 100 includes an operation acceptance section 110, an imaging section 120, a recording medium controlling section 130, a recording medium 140, an inputting/outputting section 150, an inputting controlling section 160, a control section 170, an operation information retaining section 171, and a display controlling section 180. It is to be noted that illustration and description of components of the display controlling apparatus 100 which relate to wireless communication are omitted herein.

The operation acceptance section 110 is an operation acceptance section which accepts an operation carried out by the user and outputs a control signal (operation signal) in accordance with the substance of the accepted operation to the control section 170. The operation acceptance section 110 corresponds to the first to fifth buttons 111 to 115 shown in FIG. 1.

The imaging section 120 includes an imaging device for converting light of an imaging object incoming through the lens (lens 121 shown in b of FIG. 1) into an electric signal, and an image signal processing portion for processing an output signal (imaging signal) of the imaging device to produce a picked up image (image data). In particular, in the imaging section 120, an optical image of an imaging object incoming through the lens is formed on the imaging plane of the imaging device, and in this state, the imaging device carries out an imaging operation. Then, the image signal processing portion carries out a signal process for the picked up image signal to produce a picked up image. This production of a picked up image is carried out based on starting instruction information of an imaging operation outputted from the operation acceptance section 110 or an acceptance portion 151. Then, the produced picked up image is supplied to the recording medium controlling section 130 and the display controlling section 180.

The recording medium controlling section 130 carries out controlling of recording into the recording medium 140 or reading out from the recording medium 140 under the control of the control section 170. For example, the recording medium controlling section 130 records a picked up image (image data) outputted from the imaging section 120 as still picture content (still picture file), into the recording medium 140. Further, the recording medium controlling section 130 records, for example, moving picture content (moving picture file) wherein a picked up image (image data) outputted from the imaging section 120 and sound data outputted from a sound signal processing section (not shown) are associated with each other, into the recording medium 140. Further, for example, the recording medium controlling section 130 reads out moving picture content recorded in the recording medium 140 and outputs image data included in the moving picture content to the display controlling section 180. Meanwhile, sound data included in the moving picture content are outputted from the speaker 102 (shown in b of FIG. 1).

The recording medium 140 stores various kinds of information (still picture content or moving picture content) under the control of the recording medium controlling section 130. Further, the recording medium 140 supplies various kinds of information recorded therein to the recording medium controlling section 130.

The inputting/outputting section 150 includes the acceptance portion 151 and a display portion 152. For example, as the acceptance portion 151, a touch panel of the electrostatic type (capacitive type) which detects a contacting or neighboring state of an object having conductivity (for example, a finger of a human being) based on a variation in capacitance can be used. Further, as the display portion 152, for example, a display panel such as an LCD (Liquid Crystal Display) panel or an organic EL (electroluminescence) panel can be used. Further, the inputting/outputting section 150 is configured, for example, from a transparent touch panel superposed on the display face of a display panel.

The inputting/outputting section 150 displays various images on the display portion 152 and accepts an operation input from the user by the acceptance portion 151 based on a detection state of an object which neighbors or contacts with the display face of the inputting/outputting section 150 (display face of the display portion 152) under the control of the display controlling section 180. Further, the acceptance portion 151 outputs a control signal in response to the accepted operation input to the inputting controlling section 160.

The acceptance portion 151 accepts an operation input by an object (for example, a finger of a human being) which neighbors or contacts with the display face of the inputting/outputting section 150 based on a detection state of the object. For example, the acceptance portion 151 includes a plurality of electrostatic sensors disposed in a lattice-like disposition. The electrostatic sensors are sensors whose capacitance thereof increases when an object (object having conductivity (for example, a finger or a hand of a human being)) neighbors or contacts with the display face of the inputting/outputting section 150. Then, if the capacitance of an electrostatic sensor varies, then the acceptance portion 151 outputs information (electrostatic sensor information) including a value of the capacitance of the electrostatic sensor and a position of the electrostatic sensor on the operation face of the acceptance portion 151 to the inputting controlling section 160. It is to be noted that, although an example of detection of an object which contacts with the display face of the inputting/outputting section 150 is shown, the following description can be applied similarly also to detection of an object which neighbors with the display face of the inputting/outputting section 150.

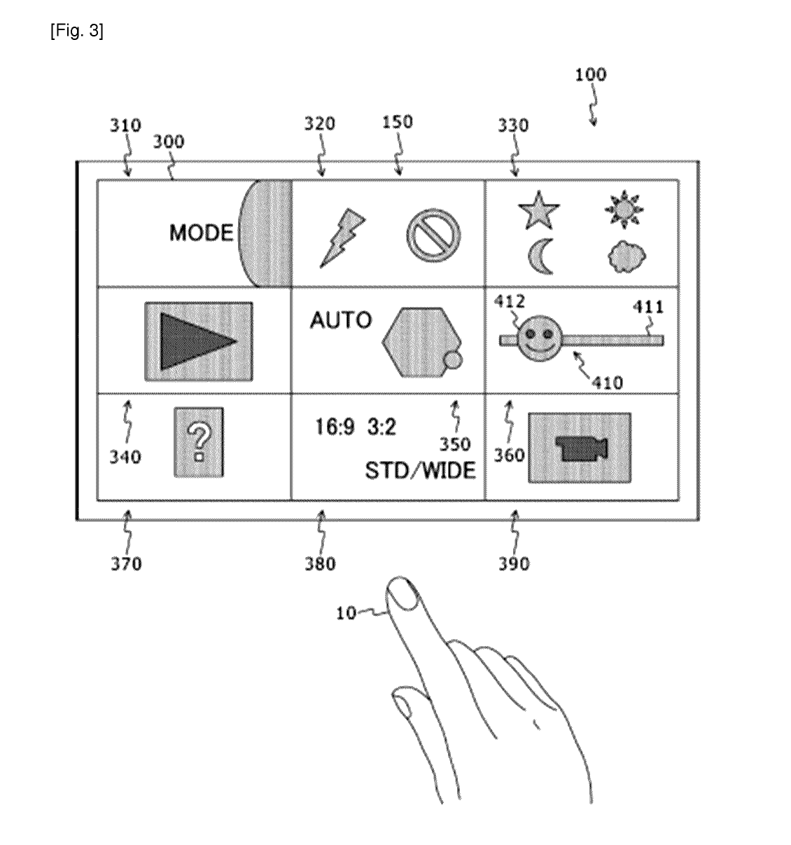

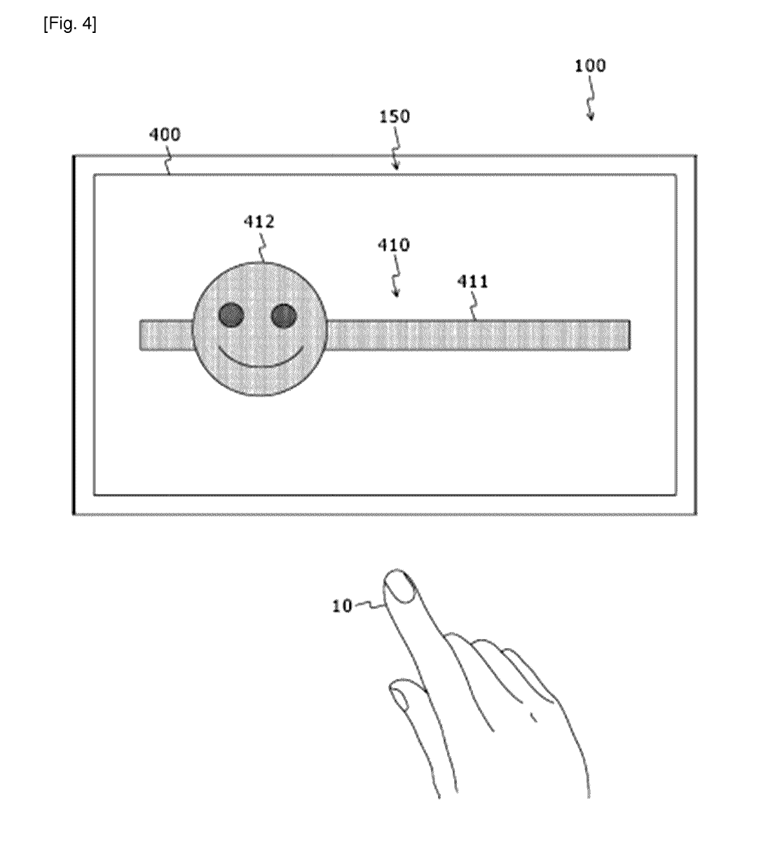

It is to be noted that the operation acceptance section 110 and the acceptance portion 151 are an example of an operation acceptance section for accepting a changeover operation for carrying out changeover between a first display screen image (for example, a menu screen image (overhead view state) 300 shown in FIG. 3) and a second display screen image (for example, a menu screen image (zoom state) 400 shown in FIG. 4). The first display screen image includes a plurality of regions for accepting a user operation. It is to be noted that, in each of the regions, operation region images (for example, a face detection system setting image 410 shown in FIG. 4) for accepting a user operation are displayed in a unit of a group. Meanwhile, the second display screen image is used to display one of the regions in an enlarged scale. Further, the acceptance portion 151 is an example of an operation acceptance section which accepts a moving operation for moving the second display screen image on the display face of the display portion 152 and detects at least one of a movement amount and an elapsed time period of the moving operation.

The display portion 152 is a display panel which displays an image under the control of the display controlling section 180. It is to be noted that examples of a display image of the display portion 152 are hereinafter described with reference to FIGS. 3 to 10 and so forth.

The inputting controlling section 160 carries out control regarding an operation input by a user accepted by the acceptance portion 151 such as, for example, a touching operation (tapping operation). For example, the inputting controlling section 160 detects a range (contact range) of the display face of the inputting/outputting section 150 within which a finger of the user touches based on electrostatic sensor information outputted from the acceptance portion 151. Then, the inputting controlling section 160 converts the contact range into coordinates based on coordinate axes corresponding to the display face. Further, the inputting controlling section 160 calculates a shape of the contact range based on the coordinates after the conversion and calculates the coordinates of the center of gravity of the shape. Further, the inputting controlling section 160 calculates the calculated coordinates of the center of gravity as coordinates of the position at which a finger of the user contacts, namely, the contact position. Then, the inputting controlling section 160 outputs the operation information regarding the calculated shape of the contact range and the coordinates of the contact position to the control section 170. The control section 170 recognizes the operation input of the user on the display face of the inputting/outputting section 150 based on the operation information (shape of the contact range, the coordinate of the contact position and so forth) outputted from the inputting controlling section 160.

The control section 170 controls the components of the display controlling apparatus 100 based on the operation signal from the operation acceptance section 110 and the operation information (shape of the contact range, the coordinates of the contact position and so forth) from the inputting controlling section 160. Further, the control section 170 retains a locus and a time period (touching operation information) of a touching operation of a user detected on the display face of the inputting/outputting section 150 into the operation information retaining section 171.

For example, the control section 170 carries out control for causing the display portion 152 to display one of the first display screen image (for example, the menu screen image (overhead view state) 300 shown in FIG. 3) and the second display screen image (for example, the menu screen image (zoom state) 400 shown in FIG. 4). Further, when a moving operation is accepted, if the moving operation satisfies a predetermined condition, then the control section 170 carries out control to display a region corresponding to the second display screen image, which was displayed upon acceptance of the moving operation and surrounding regions in a reduced scale. It is to be noted that the display control and the predetermined condition are described in detail with reference to FIGS. 3 to 10 and so forth.

The operation information retaining section 171 retains a locus and a time period (touching operation information) of a touching operation of a user detected on the display face of the inputting/outputting section 150 and supplies the retained touching operation information to the control section 170.

The display controlling section 180 outputs an image to the display portion 152 under the control of the control section 170. For example, the display controlling section 180 controls the display portion 152 to display a setting screen image (for example, the menu screen image 300 shown in FIG. 3) for carrying out various settings when an imaging operation is carried out or a picked up image (so-called through-image) outputted from the imaging section 120. Further, the display controlling section 180 controls the display portion 152 to display content (for example, still picture content or moving picture content) stored in the recording medium 140.

“Display Examples of Menu Screen Image (in an Overhead View State)”

FIG. 3 is a view showing a display screen image example (menu screen image 300) displayed on the inputting/outputting section 150 in the first embodiment of the present technology. It is to be noted that, in FIGS. 3 to 10 and so forth, the first to fifth buttons 111 to 115, speaker 101 and so forth are not shown.

The menu screen image 300 is displayed in a state in which items (operation region images) which make an operation target, are grouped in accordance with types. In particular, the grouped items are classified into nine regions in a unit of a group in a state (overhead view state) in which they are displayed in a reduced scale, and are displayed in one screen image, namely, in the menu screen image 300. It is to be noted that, to each group, similar items (for example, items relating to the same function) belong. Further, the menu screen image 300 in which the items are classified in nine regions is an example, and the number of regions may be changed suitably in response to items and so forth which make a display target.

In particular, in the menu screen image 300, an imaging mode setting region 310, a flash system setting region 320, a white balance system setting region 330, a reproduction setting region 340 and an iris adjustment region 350 are displayed. Further, a face detection system setting region 360, a guide display system setting region 370, a picked up image size system setting region 380 and a moving picture system setting region 390 are displayed in the menu screen image 300.

The imaging mode setting region 310 is a region in which items which are used when an imaging mode (still picture imaging mode or moving picture imaging mode) is set are displayed.

The flash system setting region 320 is a region in which items which are used when various settings relating to a flash are displayed.

The white balance system setting region 330 is a region in which items which are used when various settings relating to the white balance are displayed.

The reproduction setting region 340 is a region in which items for setting a reproduction mode and items which are used upon reproduction of image content are displayed.

The iris adjustment region 350 is a region in which items used for adjustment of the iris are displayed.

The face detection system setting region 360 is a region in which items used for various settings relating to face detection are displayed.

The guide display system setting region 370 is a region in which items used when various settings relating to a guide function (help function) are carried out are displayed.

In the picked up image size system setting region 380, items used when various settings relating to a size of a picked up image of an object of recording are carried out are displayed. For example, an aspect ratio (for example, 4:3 or 16:9) of a picked up image (still picture) which becomes a recording target or a picture size (STD or WIDE) of a picked up image (still picture) which becomes a recording target can be set.

In the moving picture system setting region 390, items used when various settings relating to a moving picture are carried out are displayed.

It is to be noted that the items, regions and so forth displayed on the menu screen image 300 are a mere example and can be changed suitably in response to a set mode, an imaging operation state and so forth.

Further, the items and so forth on the menu screen image 300 are operation region images (operation indicators) used when the user carries out operation inputting and can be operated by a contacting operation (for example, a touching operation or a tracing operation (dragging operation)). However, it is assumed that, on the menu screen image 300, a selection operation of only one of the nine regions is carried out, but items displayed in each region cannot be operated. Therefore, in order to select an item displayed in a region, a selection operation (touching operation) for selecting the region in which the item is displayed is carried out first, and then a display screen (zoom state) in which the selected region is displayed in an enlarged scale is displayed. An example of this display image is shown in FIG. 4.

For example, a case is assumed in which, in a state in which the menu screen image 300 is displayed on the inputting/outputting section 150, a touching operation by a finger 10 of a user is carried out on the inputting/outputting section 150. In this instance, the control section 170 decides in which one of the nine regions (310, . . . , 390) which configure the menu screen image 300, the touching operation is carried out. In particular, the control section 170 decides, based on the operation information outputted from the inputting controlling section 160, in which one of the nine regions 310 to 390 the position at which the finger of the user touches, namely, the touching position, on the display face of the inputting/outputting section 150 is included. Then, the control section 170 carries out control of displaying the region (310, . . . , 390) in which the touching position is included, in an enlarged scale on the inputting/outputting section 150. For example, an example of enlarged display when a touching operation by the finger 10 of the user is carried out in the face detection system setting region 360 is shown in FIG. 4.

“Display Example of Menu Screen Image (in a Zoom State)”

FIG. 4 shows a display screen image example (menu screen image 400) displayed on the inputting/outputting section 150 in the first embodiment of the present technology.

The menu screen image 400 is a screen image displayed when a touching operation with the face detection system setting region 360 of the menu screen image 300 shown in FIG. 3 is carried out by the user and is a screen image in which the face detection system setting region 360 is enlarged. In particular, grouped items are displayed in one screen image (menu screen image 400) in a unit of a group in an enlarged state (zoom state).

In the menu screen image 400, a face detection system setting image 410 configured from a face detection designation bar 411 and a face indicator 412 is displayed.

The face detection designation bar 411 is a bar used to select the substance of a setting relating to face detection when a face detection function is used upon setting of an imaging mode. The face indicator 412 is displayed in an overlapping relationship with the face detection designation bar 411. The substance of one of various settings can be designated by the user moving the face indicator 412 to a desired position on the face detection designation bar 411.

As shown in FIGS. 3 and 4, on the display controlling apparatus 100, a menu screen image in a reduced display state (overhead view state) in which items which become an operation target are displayed in a reduced scale and another menu screen image in an enlarged display state (zoom state) in which items which become an operation target are displayed in an enlarged scale. Further, the display of the menu screen images is changed over by a user operation (for example, a touching operation with the display face of the inputting/outputting section 150 or a depression operation of any of the first to third buttons 111 to 113).

“Examples of Display Transition between Menu Screens (in a Zoom State)”

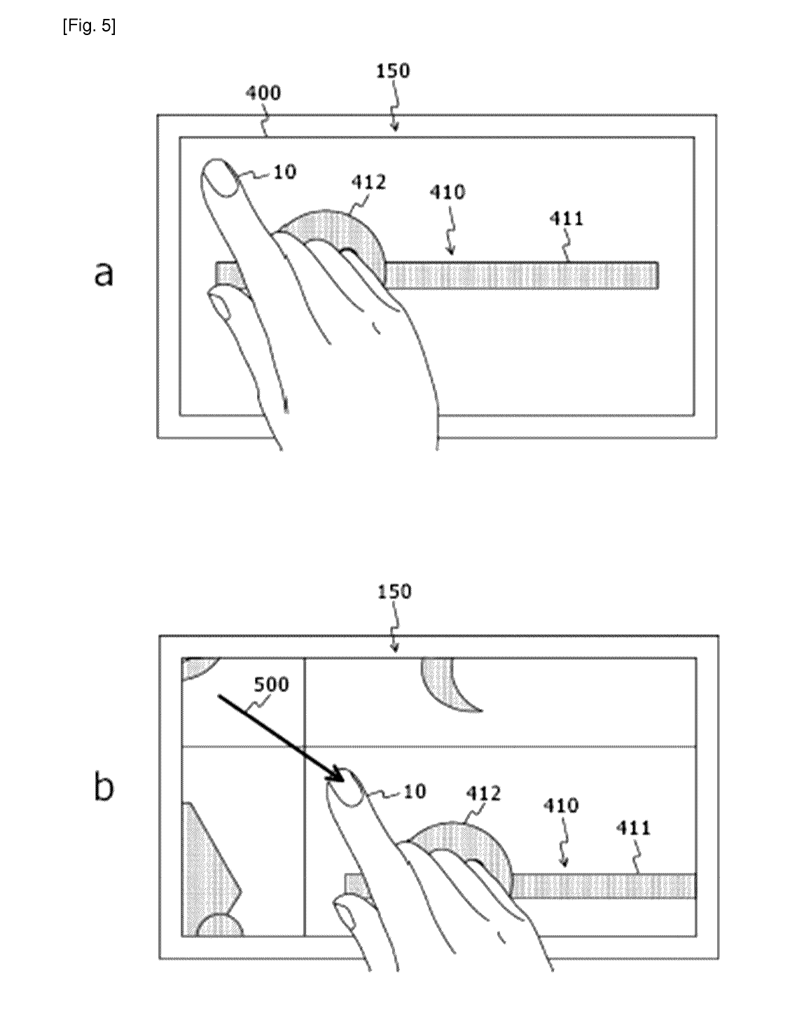

FIG. 5 is views illustrating an example of transition of a display screen image displayed on the inputting/outputting section 150 in the first embodiment of the present technology. In FIG. 5, an example of transition of a display screen image in the case where the display state of the inputting/outputting section 150 is changed from the menu screen image 400 shown in FIG. 4 to another region (region other than the face detection system setting region 360). Further, in the present example, the display screen image is changed by a touching operation with the display face of the inputting/outputting section 150.

The menu screen image 400 shown in a of FIG. 5 is similar to that shown in FIG. 4. In b of FIG. 5, an operation state when the menu screen image 400 is replaced by another menu screen image through a touching operation with the display face of the inputting/outputting section 150 is illustrated.

For example, it is assumed that, after the substance of any of various settings relating to face detection is selected by the user operation in a state in which the menu screen image 400 shown in FIG. 4 is displayed, the user causes items displayed in a different region (for example, flash system setting region 320) to be displayed. In this instance, in the state in which the finger 10 of the user touches with the menu screen image 400, the finger 10 is moved in a direction opposite to the flash system setting region 320 as seen from a and b of FIG. 5.

Here, for example as shown in FIG. 5, in order to move a menu screen image in a zoom state to a desired region by a touching operation of the user, it is necessary for the user to grasp the substance (for example, the arrangement of the regions) of the menu screen image 300 shown in FIG. 3. In particular, in the menu screen image 400, the regions other than the region which is in the enlarged display state are not displayed. Therefore, it is necessary for the user to grasp the position (position of the region among the nine regions) of the destination of the movement and carries out a touching operation (for example, a tracing operation) in the opposite direction to the position (direction indicated by an arrow mark 500).

However, also it is anticipated that the user does not grasp the substance (for example, the arrangement of the regions) of the menu screen image 300 shown in FIG. 3. In such a case as just described, if it is intended to move a menu screen image in a zoom state to a desired region by a touching operation of the user, then since the user does not grasp the position of the region of the destination of the movement, the user will carry out a touching operation while searching for the region. Therefore, there is the possibility that an appropriate smooth movement cannot be carried out in a virtual space.

Therefore, in the first embodiment of the present technology, an example wherein, when the user wavers in a touching operation in a display state of a menu screen image in a zoom state, a menu screen image in an overhead view state or the like is displayed so that the user can rapidly grasp the substance of the menu screen image is described.

“Example of Display Transition Based on Touching Operation”

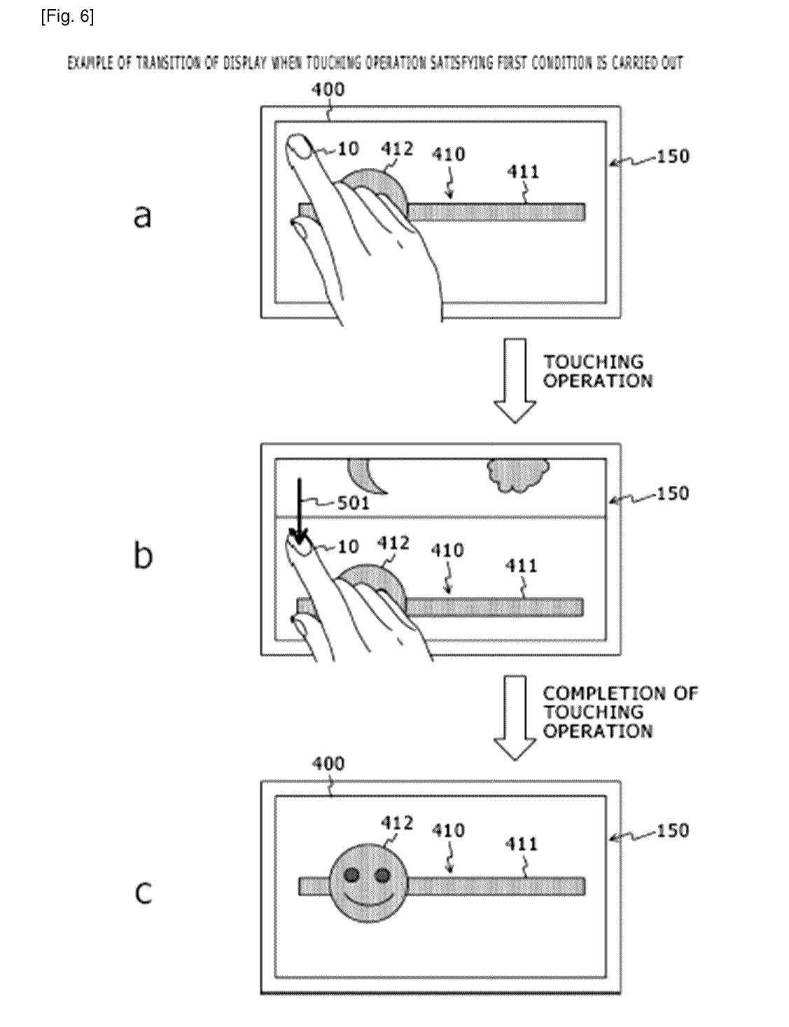

FIGS. 6 to 9 are views illustrating examples of transition of a display screen image displayed on the inputting/outputting section 150 in the first embodiment of the present technology.

Here, in the first embodiment of the present technology, an example wherein, when a tracing operation (dragging operation) is carried out as a touching operation by the user, the display screen image is moved in response to the tracing operation is described.

Further, a period of time from a point of time (operation starting time point) at which a touching operation by the user is started to another point of time (operation ending time point) at which the touching operation is ended on the display face of the inputting/outputting section 150 is represented as elapsed time T. Further, an amount of movement from a position (operation starting position) at which a touching operation by the user is started to another position (operation ending position) at which the touching operation is ended is represented as movement amount d. It is to be noted that the movement amount d is, for example, a locus (for example, a locus per unit time period) from the operation starting position to the operation ending position.

If a touching operation by the user is carried out on the display face of the inputting/outputting section 150, the control section 170 calculates the elapsed time T and the movement amount d of the touching operation based on operation information from the inputting controlling section 160. Then, the control section 170 successively retains the calculated elapsed time T and movement amount d into the operation information retaining section 171.

Then, the control section 170 compares the elapsed time T and the movement amount d retained in the operation information retaining section 171 with threshold values at a point of time (operation ending time point) at which the touching operation by the user is ended and carries out control for displaying a display screen image in accordance with the touching operation. In particular, the control section 170 uses values A, B and C as the threshold values to decide whether or not the first to fourth conditions given below are satisfied. Then, based on a result of the decision, a display screen image corresponding to the toughing operation is displayed.

First condition: T×d<A

Second condition: A=<T×d<B

Third condition: B=<T×d<C

Fourth condition: C=<T×d

Here, X=<Y means that X is less than or equal to Y.

Here, if the first condition is satisfied, then this is a case in which both of the elapsed time T and the movement amount d are small. Therefore, it is considered that the first condition is satisfied in such a situation that, for example, although it is tried to change the displayed menu screen image to another menu screen image (zoom state) which is in a neighboring region, the change is stopped for some reason. It is to be noted that the reason in this instance may be that it is intended, for example, to confirm settings on a menu screen image (zoom state) upon starting of a touching operation once again. Therefore, when the first condition is satisfied, the menu screen in a zoom state upon starting of the touching operation is displayed. In other words, when the first condition is satisfied, the display state before the operation is maintained. An example of the display in this instance is shown in FIG. 6.

FIG. 6 illustrates an example of transition of display when a touching operation by the user is carried out. In a of FIG. 6, an example of a display screen image upon starting of a touching operation by the user is shown, and in b of FIG. 6, an example of a display screen image upon ending of the touching operation by the user is shown. In particular, in FIG. 6, a display transition example in the case where the movement amount d is comparatively small as indicated by an arrow mark 501 and the elapsed time T has a comparatively low value (in the case where the first condition is satisfied) is shown.

In c of FIG. 6, an example of a display screen image displayed after the ending of the touching operation by the user illustrated in b of FIG. 6 is shown. As described hereinabove, when the first condition is satisfied, the menu screen image (zoom state) upon starting of the touching operation is displayed on the inputting/outputting section 150.

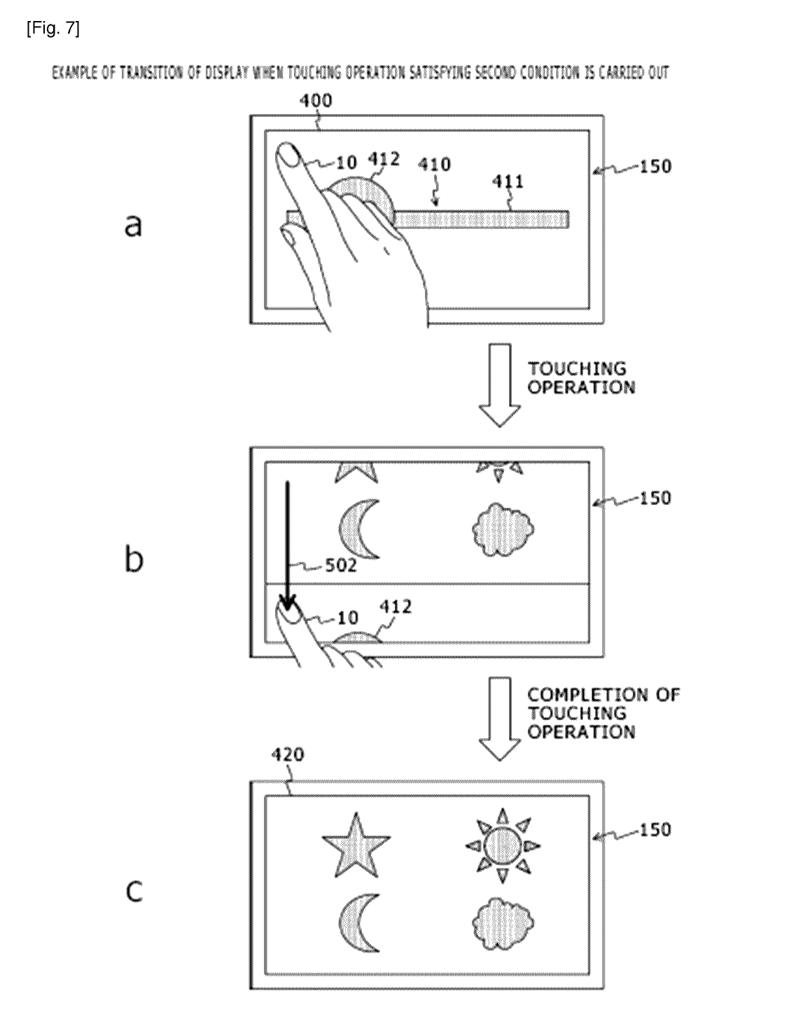

On the other hand, if the second condition is satisfied, then the elapsed time T×movement amount d has a fixed value (operation amount by which the displayed menu screen image is changed to a menu screen image (zoom state), for example, in a neighboring region). For example, if the user knows a neighboring region, then it is anticipated that the operation is carried out fast and also the movement amount has a fixed value. Therefore, when the second condition is satisfied, it is considered that, for example, the user knows a neighboring region and has a will to change the displayed menu screen image to a menu screen image (zoom state) in the neighboring region. Therefore, when the second condition is satisfied, the menu screen image (zoom state) in a neighboring region is displayed. In other words, when the second condition is satisfied, a display screen image (menu screen image (zoom state) in a neighboring region) different from the display screen image in the display state before the operation. This display example is shown in FIG. 7.

FIG. 7 illustrates an example of transition of display when a touching operation by the user is carried out. In particular, a of FIG. 7 shows an example of a display screen image upon starting of a touching operation by the user, and b of FIG. 7 shows an example of a display screen image upon ending of the touching operation by the user. In other words, FIG. 7 illustrates a display transition example in the case where the movement amount d has a fixed value as indicated by an arrow mark 502 and the elapsed time T has a comparatively low value, for example (in the case where the second condition is satisfied).

In c of FIG. 7, an example of a display screen image displayed after ending of the touching operation by the user illustrated in b of FIG. 7 is shown. As described hereinabove, when the second condition is satisfied, the menu screen image (zoom state) 420 in a neighboring region is displayed on the inputting/outputting section 150. In this manner, in the case where the user already grasps the entire menu screen image, the displayed menu screen image can be rapidly changed to a menu screen image in a desired zoom state.

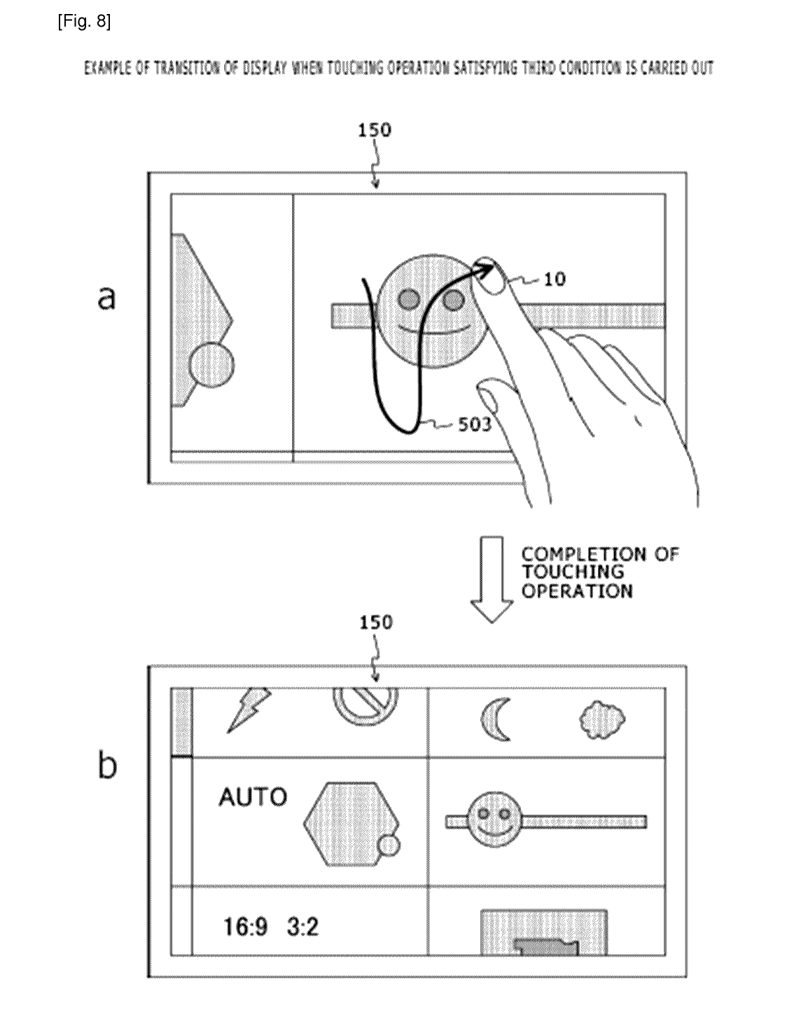

When the third condition is satisfied, the elapsed time T×movement amount d exhibits a value higher than a fixed value (for example, fixed value used in the second condition). Therefore, when the third condition is satisfied, it is considered that, for example, the user has a will to change the displayed menu screen image to a different menu screen image (zoom state) and knows the positions of the regions to some degree and besides is seeking for a desired menu screen image (zoom state). In this manner, when the third condition is satisfied, since it is estimated that the user knows the positions of the regions to some degree, regions around the menu screen image in a zoom state upon starting of the touching operation are displayed. In other words, when the third condition is satisfied, a display screen image (a display screen image (intermediate state) including the menu screen image (zoom state) 400 upon the starting of the touching operation) different from the display state before the operation is displayed. An example of this display is shown in FIG. 8.

In particular, a of FIG. 8 shows an example of a touching operation by the user. It is estimated that, in a of FIG. 8, the movement amount d has a value higher than the fixed value as indicated an arrow mark 503, for example, and also the elapsed time T has a comparatively high value, namely, the third condition is satisfied.

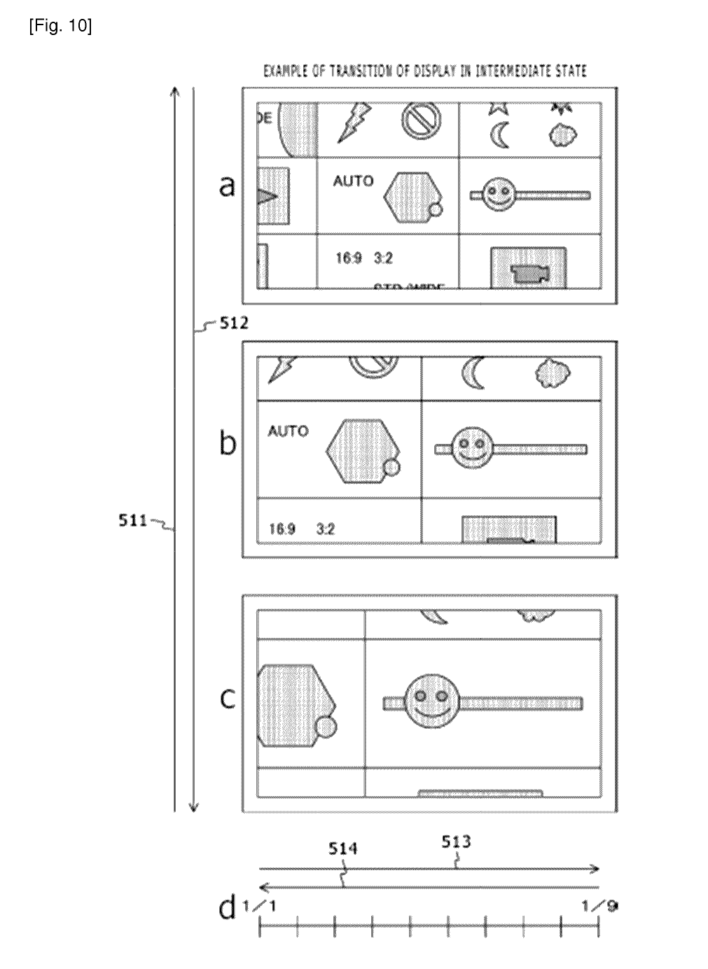

In b of FIG. 8, an example of a display screen image displayed after ending of the touching operation by the user illustrated in a of FIG. 8 is shown. As described hereinabove, when the third condition is satisfied, a display screen image (intermediate state) including the menu screen image (zoom state) 420 upon starting of the touching operation is displayed on the inputting/outputting section 150 such that it is zooming out. Further, when the menu screen image in an intermediate state is displayed, after a fixed period of time elapses after the displaying of the menu screen image in the intermediate state, the menu screen image (zoom state) 420 upon the starting of the touching operation is displayed. By providing an intermediate state, which fills a gap between the zoom state and the overhead view state, to the user in this manner, the user can readily grasp a relationship between the current display position and menu items around the same. It is to be noted that an example of display transition of an intermediate state is illustrated in FIG. 10.

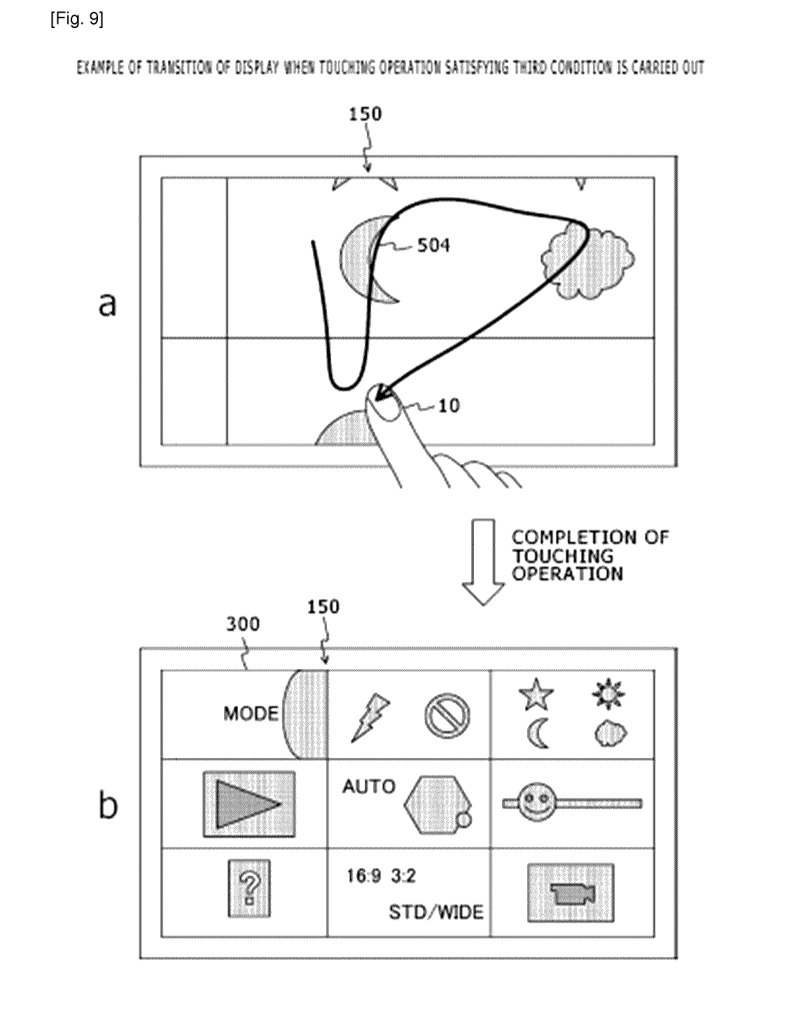

When the fourth condition is satisfied, the elapsed time T×movement amount d exhibits a comparatively high value (for example, a value higher than the value used in the third condition). Therefore, when the fourth condition is satisfied, although the user has a will to change the displayed menu screen image to a different menu screen image (zoom state), the user wavers in seeking for a desired menu screen image (zoom state). Further, since the user is wavering, also it is estimated that the operation is slowed down. Therefore, when the fourth condition is satisfied, the menu screen image (overhead view state) is displayed. In other words, when the fourth condition is satisfied, a display screen image (menu screen image (overhead view state)) different from the display state before the operation is displayed. This display example is shown in FIG. 9.

In a of FIG. 9, an example of a touching operation by the user is illustrated. For example, in a of FIG. 9, the movement amount d exhibits a comparatively higher value than the fixed value as indicated by an arrow mark 504, and also the elapsed time T exhibits a comparatively high value (a case in which the fourth condition is satisfied).

In b of FIG. 9, an example of a display screen image displayed after ending of the touching operation by the user shown in a of FIG. 9 is shown. As described hereinabove, when the fourth condition is satisfied, the menu screen image (zoom state) 400 is displayed on the inputting/outputting section 150 in such a manner as to zoom out. In this manner, even if the user does not carry out an operation (operation for returning to the higher hierarchy) for returning to the menu screen image (overhead view state) 400, the display state can be returned to a state in which the entire display screen image can be grasped by a smooth movement of the point of view in a virtual space.

It is to be noted that, when such display transitions (display transitions from the end of the touching operation) shown in FIGS. 6 to 9 are carried out, for example, a linear animation from an original display screen image may be used. In this instance, the control section 170 carries out control for displaying a transition between screen images by an animation.

Further, for the threshold values A to C, values set in advance may be used. Further, threshold values A to C suitable for the user may be set by learning a relationship between the movement amount and the elapsed time, for example, using a statistical technique. Or, threshold values A to C conforming to likings of the user may be set by a user operation.

In this manner, one of a first display screen image (for example, the menu screen image (overhead view state) 300 shown in FIG. 3) and a second display screen image (for example, the menu screen image (zoom state) 400 shown in FIG. 4) is displayed on the display portion 152 based on a changeover operation by the user. Further, when a moving operation is accepted, if the moving operation satisfies a predetermined condition (for example, the third condition or the fourth condition), then the control section 170 carries out control for displaying a region corresponding to the second display screen image displayed upon acceptance of the moving operation and regions around the region in a reduced scale. In this instance, for example, if at least one of the movement amount and the elapsed time of the touching operation by the user on the display face satisfies the predetermined condition, then the control section 170 carries out control for displaying the region corresponding to the second display screen image and regions around the region in a reduced scale. For example, when a value specified from at least one of the movement amount and the elapsed time is higher than the threshold value, the control section 170 decides that the predetermined condition is satisfied. It is to be noted that an example wherein one of the movement amount and the elapsed time is used is described in connection with a second embodiment of the present technology. Further, when the moving operation satisfies a predetermined condition (for example, the third condition), the control section 170 carries out control for displaying the second display screen image after the lapse of a predetermined period of time after the reduction display is carried out. Further, when the moving operation satisfies another predetermined condition (for example, the fourth condition), the control section 170 carries out control for displaying the first display screen image.

“Example of Display Transition of Intermediate State”

FIG. 10 is views illustrating an example of transition of a display screen image displayed on the inputting/outputting section 150 in the first embodiment of the present technology.

Particularly, a to c of FIG. 10 illustrate an example of transition of display of a menu screen image in an intermediate state. Meanwhile, d of FIG. 10 shows graduations corresponding to a scale relating to enlargement or reduction. Among the graduations, the graduation 1/1 represents a numerical value corresponding to a menu screen image in an overhead view state. The graduation 1/9 represents a numerical value corresponding to a menu screen image in a zoom state. Further, display transition in the direction indicated by an arrow mark 511 shown in a to c of FIG. 10 corresponds to transition of the zoom ratio in the direction indicated by an arrow mark 513 illustrated in d of FIG. 10. Display transition in the direction indicated by an arrow mark 512 shown in a to c of FIG. 10 corresponds to transition of the zoom ratio in the direction indicated by an arrow mark 514 shown in d of FIG. 10.

For example, when the third condition is satisfied, a display screen image (intermediate state) including the menu screen image (zoom state) 420 upon starting of the touching operation is displayed on the inputting/outputting section 150 as seen in b of FIG. 8. In this instance, the control section 170 can determine a zoom ratio of the menu screen image of an intermediate state based on the magnitude of a value (value (elapsed time T×movement amount d) which satisfies the third condition) of a target of comparison.

For example, if the value of a comparison target is comparatively low, the zoom ratio of the menu screen image in the intermediate state can be made low (for example, approximately ⅙ to ⅛ of the graduations shown in d of FIG. 10). On the other hand, if the value of the comparison target is comparatively high, then the zoom ratio of the menu screen image in the intermediate state can be made high (for example, approximately ½ to ¼ of the graduations shown in d of FIG. 10). Further, if the value of the comparison target is an intermediate value between them, then the zoom ratio of the menu screen image in the intermediate state can be set to an intermediate degree (for example, approximately ¼ to ⅙ of the graduations shown in d of FIG. 10).

In this manner, the control section 170 determines a reduction ratio (zoom ratio) upon reduction display based on the magnitude of the value specified at least based on the movement amount and the elapsed time of the touching operation on the display face by the user.

Further, when the menu screen image in an intermediate state whose zoom ratio is determined in such a manner as described above is to be displayed, display transition from the original menu screen image in the zoom state to the menu screen image in the intermediate state may be displayed by an animation. Similarly, display transition from the menu screen image in the intermediate state to the original menu screen image in a zoom state may be displayed by an animation.

Further, when the menu screen image in the intermediate state whose zoom ratio is determined in this manner is to be displayed, the menu screen image in the intermediate state may be displayed with reference to the touching position on the original menu screen image in the zoom state. In particular, the menu screen image in the intermediate state may be displayed such that the touching position on the menu screen image in the zoom state may become the same position on the display face of the inputting/outputting section 150.

“Example of Operation of Display Controlling Apparatus”

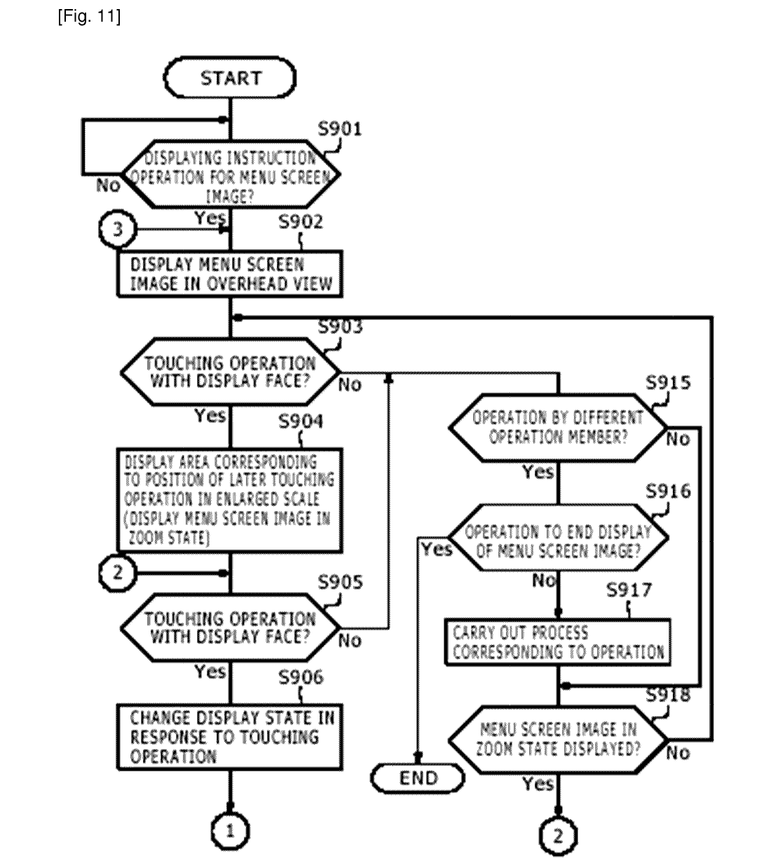

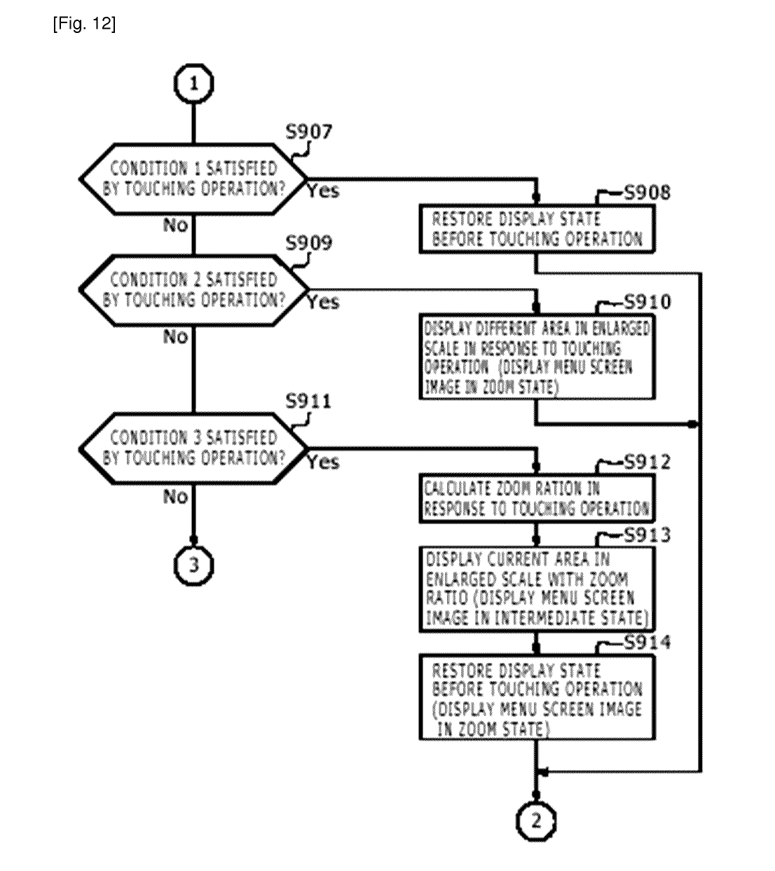

FIGS. 11 and 12 illustrate an example of a processing procedure of a display controlling process by the display controlling apparatus 100 in the first embodiment of the present technology.

The control section 170 first decides whether or not a display instruction operation of a menu screen image is carried out (step S901). If a display instruction operation of a menu screen image is not carried out, then the control section 170 continuously carries out this monitoring. If a display instruction operation of a menu screen image is carried out (step S901), then the display controlling section 180 controls the display portion 152 to display a menu screen image in an overhead view state based on the instruction of the control section 170 (step S902). For example, the menu screen image 300 shown in FIG. 3 is displayed.

Then, the control section 170 decides whether or not a touching operation with the display face of the inputting/outputting section 150 is carried out (step S903). Then, if a touching operation with the display face is carried out (step S903), then the display controlling section 180 causes an area corresponding to the position of the touching operation to be displayed in an enlarged scale based on the instruction from the control section 170 (step S904). In particular, the menu screen image in a zoom state is displayed on the display portion 152 (step S904.) For example, if a touching operation with the face detection system setting region 360 on the menu screen image 300 shown in FIG. 3 is carried out, then the menu screen image 400 shown in FIG. 4 is displayed.

Then, the control section 170 decides whether or not a touching operation with the display face of the inputting/outputting section 150 is carried out (step S905). Then, if a touching operation with the display face is carried out (step S905), then the display controlling section 180 causes the display state to be changed in response to the touching operation based on the instruction of the control section 170 (step S906). For example, the display state of the menu screen image 400 is changed as shown in a and b of FIG. 5.

Then, the control section 170 then decides whether or not the touching operation satisfies the first condition (step S907). Then, if the touching operation satisfies the first condition (step S907), then the display controlling section 180 restores the display state before the touching operation based on the instruction of the control section 170 (step S908).

On the other hand, if the touching operation does not satisfy the first condition (step S907), then the control section 170 decides whether or not the touching operation satisfies the second condition (step S909). Then, if the touching operation satisfies the second condition (step S909), then the display controlling section 180 causes a different area to be displayed in an enlarged scale in response to the touching operation based on the instruction of the control section 170 (step S910). For example, a menu screen image (zoom state) in a neighboring region is displayed as seen in FIG. 7.

On the other hand, if the touching operation does not satisfy the second condition (step S909), then the control section 170 decides whether or not the touching operation satisfies the third condition (step S911). Then, if the touching operation satisfies the third condition (step S911), then the control section 170 calculates a zoom ratio in response to the touching operation (step S912). Then, the display controlling section 180 causes the region upon starting of the touching operation to be displayed in an enlarged scale at the calculated zoom ratio based on the instruction of the control section 170 (step S913). For example, regions around the menu screen image (zoom state) upon starting of the touching operation are displayed as seen in b of FIG. 8. In other words, menu screen images in an intermediate state including the menu screen image (zoom state) upon starting of the touching operation are displayed.

Then, the display controlling section 180 restores the display state before the touching operation based on the instruction of the control section 170 (step S914). For example, the display state before the touching operation is restored after the lapse of a fixed period of time (step S914). On the other hand, if the touching operation does not satisfy the third condition (step S911), then the processing advances to step S902.

In particular, if the touching operation does not satisfy any of the first to third conditions (steps S907, S909 and S911), then the fourth condition is satisfied. Therefore, the display controlling section 180 controls the display portion 152 to display the menu screen image in an overhead view state based on the instruction of the control section 170 (step S902).

On the other hand, if a touching operation with the display face is not carried out (steps S903 and S905), then the control section 170 decides whether or not an operation of a different operation member is carried out (step S915). If an operation of a different operation member is not carried out (step S915), then the processing advances to step S918. On the other hand, if an operation of a different operation member is carried out (step S915), then the control section 170 decides whether or not the operation is a display ending operation of the menu screen image (step S916). Then, if the operation is a display ending operation of the menu screen image (step S916), then the operation of the display controlling process is ended.

On the other hand, if the operation is not the display ending operation of the menu screen image (step S916), then the control section 170 carries out a process in accordance with the operation (step S917). Then, it is decided whether or not the menu screen image in the zoom state is displayed (step S918). Then, if the menu screen image in the zoom state is displayed, then the processing returns to step S905. On the other hand, if the menu screen image in the zoom state is not displayed (step S918), then the processing returns to step S903.

It is to be noted that the steps S903, S904 and S915 to S917 are an example of a first controlling procedure. Meanwhile, the steps S902 and S911 to S914 are an example of a second controlling procedure.

### 2. Second Embodiment

In the first embodiment of the present technology, an example of transition of a display screen image having a hierarchical structure of two hierarchies (a menu screen image in an overhead view state and another menu screen in a zoom state) is described. The first embodiment of the present technology can be applied also to another display screen image having a hierarchical structure of three or more hierarchies.

Therefore, in a second embodiment of the present technology, an example of transition of a display screen image having a hierarchical structure of three hierarchies is described. It is to be noted that the display controlling apparatus according to the second embodiment of the present technology has a substantially similar configuration to that in the example shown in FIGS. 1, 2 and so forth. Therefore, description of common elements to those in the first embodiment of the present technology is partly omitted herein.

“Example of Transition of Display Screen”

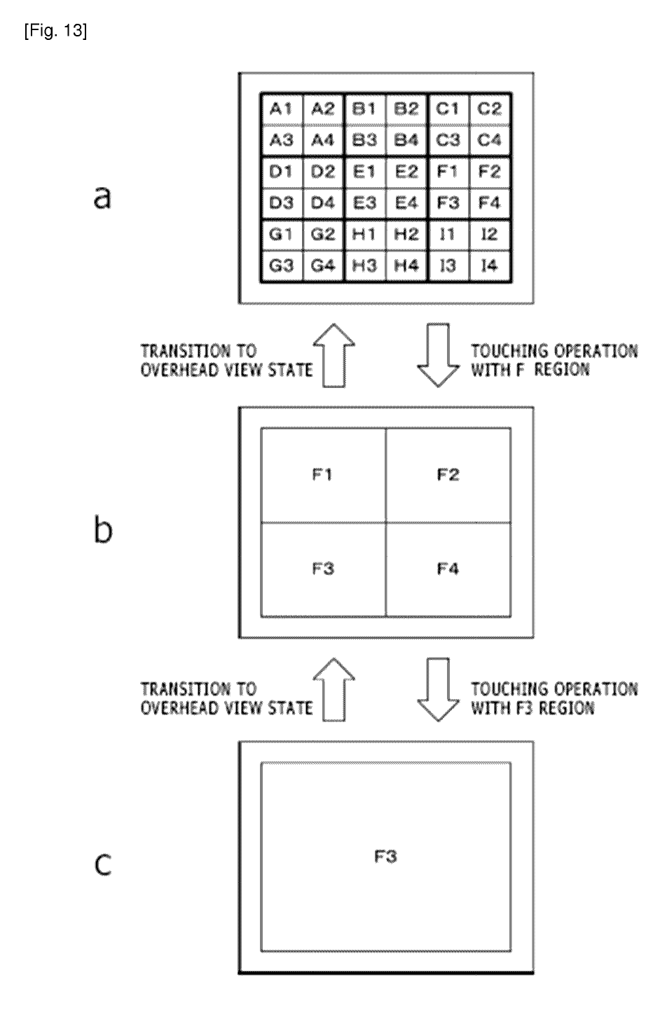

FIG. 13 is views illustrating an example of transition of a display screen image displayed on the inputting/outputting section 150 in the second embodiment of the present technology. In FIG. 13, a transition example of a display screen having a hierarchical structure of three hierarchies is shown.

In a of FIG. 13, an example of display of a menu screen image of the highest hierarchy is shown. It is to be noted that regions of the menu screen image separated by thick lines shown in a of FIG. 13 correspond to the nine regions (310, . . . , 390) in the first embodiment of the present technology.

In b of FIG. 13, an example of display of a menu screen image of a lower hierarchy with respect to the menu screen image shown in a of FIG. 13 is shown. It is to be noted that the menu screen image shown in b of FIG. 13 is a menu screen image which is displayed when a touching operation with an F region (one of regions F1 to F4) of the menu screen image shown in a of FIG. 13. In particular, if a touching operation with one of the regions F1 to F4 of the menu screen image shown in a of FIG. 13 is carried out, then the menu screen image shown in b of FIG. 13 is displayed. It is to be noted that display transition in the case where a touching operation with the menu screen image shown in b of FIG. 13 is carried out is substantially similar to that in the first embodiment of the present technology.

In c of FIG. 13, an example of display of a menu screen image of a lower hierarchy (lowermost hierarchy) with respect to the menu screen image shown in b of FIG. 13 is shown. It is to be noted that the menu screen image shown in c of FIG. 13 is displayed when a touching operation with the region F3 of the menu screen image shown in b of FIG. 13 is carried out. Here, with regard to display transition in the case where a touching operation with the menu screen image shown in c of FIG. 13 is carried out, that in the first embodiment of the present technology can be applied. In particular, in response to which one of the first to fourth conditions used in the first embodiment of the present technology is satisfied, display transition corresponding to the condition is carried out. However, if the touching operation with the menu screen image shown in c of FIG. 13 satisfies the fourth condition, the menu screen image shown in b of FIG. 13 is displayed as a menu screen image in an overhead view state. On the other hand, when the touching operation satisfies the third condition, a menu screen image of a zoom ratio ( 1/9 to 1/36) between the menu screen image shown in b of FIG. 13 and the menu screen image shown in c of FIG. 13 is displayed as the menu screen image in the intermediate state.

For example, it is considered that some person may waver in the second hierarchy shown in b of FIG. 13 or another person may waver in the third hierarchy shown in c of FIG. 13. Therefore, in whichever one of the second hierarchy and the third hierarchy the user wavers, the menu screen image in the overhead view state or a menu screen image in the intermediate state is displayed.

It is to be noted that, in FIG. 13, an example wherein, when the fourth condition is satisfied in the third hierarchy shown in c of FIG. 13, the menu screen image in the second layer shown in b of FIG. 13 is displayed is shown. However, for example, in such a case that the user wavers much in the third hierarchy shown in c of FIG. 13, the menu screen in the first hierarchy shown in a of FIG. 13 may be displayed directly.

It is to be noted that, while, in FIG. 13, an example wherein each of the regions of the menu screen image in the highest hierarchy is divided into four regions for different classes (for example, regions F1 to F4 in the F region), each region may otherwise be divided into a number of regions other than four.

Further, while, in FIG. 13, an example of transition of a display screen image having a hierarchical structure of three layers is described, such transition can be applied also to a display screen having a hierarchical structure of four or more hierarchies.

### 3. Third Embodiment

In the first embodiment of the present technology, an example wherein it is decided based on a comparison result of the elapsed time T and the movement amount d with threshold values whether or not the first to fourth conditions are satisfied. However, whether or not the first to fourth conditions are satisfied may be decided based on a result of comparison of a different value such as, for example, the elapsed time T or the movement amount d, with threshold values. Or, some other criterion may be used.

Therefore, in a third embodiment of the present technology, an example wherein a different criterion is used is described. It is to be noted that the display controlling apparatus according to the second embodiment of the present technology has a substantially similar configuration to that in the example shown in FIGS. 1, 2 and so forth. Therefore, description of common elements to those in the first embodiment of the present technology is partly omitted herein.

“Example in Which Only Movement Amount Is Used as Comparison Result”

In this instance, it is possible to set the threshold values A to “A=approximately 50%” (one half the display screen), set the threshold values C to “C=approximately 80 to 300%” and set the threshold value B to “B=a value between A and C”. Further, by learning a relationship between the movement amount and the user operation, for example, using a statistical method, the threshold values A to C conforming to likings of the user can be set. Or, the threshold values A to C conforming to likings of the user may be set by a user operation. It is to be noted that, as the movement amount d, a movement amount from starting time to ending time of a touching operation of the user or a movement amount per unit time period may be used.

“Example in Which Only Elapsed Time Is Used as Comparison Result”

In this instance, threshold values A to C set in advance can be used. Further, threshold values A to C suitable for the user can be set by learning a relationship between the elapsed time and the user operation, for example, using a statistical technique. Or, threshold values A to C conforming to likings of the user may be set by a user operation.

“Example in Which Different Criterion Is Used”

As described hereinabove, a criterion different from the elapsed time T and the movement amount d may be used. For example, in the case where a locus from starting of a touching operation is substantially linear, when the locus of the later touching operation changes from the linear state, it can be decided that the user comes to waver. In this instance, the display state can be changed from the menu screen image in a zoom state to the menu screen image in an overhead view state.

For example, it is assumed that a specific direction of the display screen (for example, a leftward and rightward direction) is defined as X axis and a direction perpendicular to the specific direction (for example, an upward and downward direction) is defined as Y axis. In this instance, if such a state arises that, after the locus increases by a fixed amount on the X axis and the Y axis after starting of a touching operation, then the locus disappears or decreases on the X axis and increases only on the Y axis, then it can be decided that the user comes to waver.

Further, in addition to a tracing operation (for example, a drag operation), for example, a touching operation and elapsed time thereof, a flick operation and elapsed time thereof, a number of touching operations, a period of time for which a corner of a display screen is touched and so forth may each be used as a criterion. For example, whether or not the first to fourth conditions are satisfied can be decided based on a result of comparison between the values of such parameters mentioned above and the threshold values A to C.

“Example in Which Decision Is Made During Touching Operation”

In the first to third embodiments of the present technology, an example wherein a decision of whether or not the first to fourth conditions are satisfied is made after a touching operation comes to an end. However, the decision of whether or not the first to fourth conditions are satisfied may be carried out successively while a touching operation is carried out continuously such that the display screen state is successively changed during the touching operation based on a result of the decision.

In this manner, in the embodiments of the present technology, the zoom ratio or the display position is changed in response to a user operation to dynamically change over the position of the point of view in a virtual space displayed in an enlarged or reduced scale. In particular, while data disposed in a virtual space is displayed in an enlarged scale (zoom state), a particular behavior of the user is detected and a state in accordance with a type of the user operation (a state in which the screen menu image can be grasped entirely or partly (overhead view state)) can be provided temporarily. In other words, in the case where it is considered that the user wavers, the zoom ratio or the display position is changed over dynamically in response to the wavering such that peripheries of the display screen image before the operation are displayed. Consequently, a smooth movement in a virtual space can be carried out readily, and an appropriate menu screen image in accordance with an operation situation of the user can be provided.

Further, the user can carry out item selection to an intended object readily without dropping the immediacy and besides can readily grasp a relationship between the full menu screen image (overhead view state) and the current display position (zoom state). In this manner, assistance in transition to a state desired by the user can be carried out readily. Further, even in the case where a very large number of objects are to be displayed, by using a display screen of a hierarchical structure of a plurality of hierarchies, a relationship between the overhead view state and the zoom state can be grasped readily.

It is to be noted that, while, in the embodiments of the present technology, an example wherein a touch panel of the electrostatic type (capacitive type) is used is described, a touch panel of the pressure-sensitive type (resistance film type) or of the optical type may be used.

Further, in the embodiments of the present technology, description is given taking a display controlling apparatus for a wireless communication apparatus as an example. However, the embodiments of the present technology can be applied also to other display controlling apparatus (electronic apparatus) wherein a virtual space is displayed in an enlarged or reduced scale or the position of the point of view can be changed over in the virtual space. For example, the embodiments of the present technology can be applied to various apparatus such as a digital still camera, a digital video camera (for example, a recorder integrated with a camera), a digital photo frame, a smartphone, a tablet, a digital signage terminal, a vending machine and a car navigator.

It is to be noted that the embodiments described above are examples for embodying the present technology, and items in the embodiments and features described in the accompanying claims individually have a corresponding relationship. Similarly, the features in the claims and items in the embodiments of the technology having same names individually have a corresponding relationship. However, the present technology is not limited to the embodiments, but can be carried out by applying various modifications to the embodiments without departing from the subject matter of the present technology.

Further, the processing procedure presented in the description of the embodiments described hereinabove may be regarded as a method having the series of processes or may be grasped as a program for causing the series of procedures to be executed by a computer or a recording medium in which the program is stored. As the recording medium, for example, a CD (Compact Disc), an MD (MiniDisc), a DVD (Digital Versatile Disk), a memory card, a Blu-ray disk (Blu-ray Disc (registered trademark)) and so forth can be used.

It is to be noted that the present technology can take also such configurations as given below:

(1) An information processing apparatus comprising: circuitry configured to control a display to display first image data; acquire sensor output corresponding to a touch input received at the display; and control the display to display second image data based on a duration and distance corresponding to the touch input.

(2) The information processing apparatus of (1), wherein the circuitry is configured to calculate a value corresponding to the duration and distance corresponding to the touch input.

(3) The information processing apparatus of (2), wherein the circuitry is configured to compare the calculated value to a predetermined threshold value.

(4) The information processing apparatus of (3), wherein the circuitry is configured to control the display to display the second image data based on the comparison.

(5) The information processing apparatus of any one of (2) to (4), wherein the circuitry is configured to calculate the value by multiplying a first value corresponding to the duration of the touch input with a second value corresponding to the distance of the touch input.

(6) The information processing apparatus of (5), wherein the circuitry is configured to compare the calculated value to a first threshold value and control the display to display the first image data as the second image data when the calculated value is less than the first threshold value.

(7) The information processing apparatus of (6), wherein the circuitry compares the calculated value with a second threshold value when the calculated value is greater than or equal to the first threshold value.

(8) The information processing apparatus of (7), wherein the circuitry is configured to control the display to display image data neighboring the first image data as the second image data when the calculated value is less than the second threshold value.

(9) The information processing apparatus of (7), wherein the circuitry is configured to compare the calculated value with a third threshold value when the calculated value is greater than or equal to the second threshold value.

(10) The information processing apparatus of (9), wherein the circuitry is configured to control the display to display the first image data and first neighboring image data corresponding to a first area neighboring the first image data as the second image data when the calculated value is less than the third threshold value.

(11) The information processing apparatus of (9), wherein the circuitry is configured to control the display to display the first image data, first neighboring image data corresponding to a first area neighboring the first image data and second neighboring image data corresponding to a second area neighboring the first area as the second image data when the calculated value is greater than or equal to the third threshold value.

(12) The information processing apparatus of (11), wherein the first image data corresponds an item in a menu.

(13). The information processing apparatus of (12), wherein the first neighboring image data corresponds to items of the menu that neighbor the item displayed as the first image data.

(14) The information processing apparatus of (13), wherein the entire menu is displayed when the display is controlled to display the first image data, the first neighboring image data corresponding to the first area neighboring the first image data and second neighboring image data corresponding to a second area neighboring the first area.

(15) The information processing apparatus of any of (1) to (14), wherein the first image data corresponds to a first hierarchical item in a menu structure.

(16) The information processing apparatus of (15), wherein the second image data corresponds to a second hierarchical item in the menu structure that is at a different level of the menu structure than the first hierarchical item.

(17) The information processing apparatus of any of (5) to (15), wherein the first image data corresponds to a first hierarchical item in a menu structure, and the circuitry is configured to compare the calculated value to a first threshold value and control the display to display the first hierarchical item as the second image data when the calculated value is less than the first threshold value.

(18) The information processing apparatus of (17), wherein the circuitry compares the calculated value with a second threshold value when the calculated value is greater than or equal to the first threshold value.

(19) The information processing apparatus of (18), wherein the circuitry is configured to control the display to display image data corresponding to a second hierarchical item in the menu structure that is on a same level of the menu structure as the first hierarchical item as the second image data when the calculated value is less than the second threshold value.

(20) The information processing apparatus of (19), wherein the circuitry is configured to compare the calculated value with a third threshold value when the calculated value is greater than or equal to the second threshold value.

(21) The information processing apparatus of (20), wherein the circuitry is configured to control the display to display a third hierarchical item in the menu structure that is superior to the first hierarchical item in the menu structure as the second image data when the calculated value is less than the third threshold value.

(22) The information processing apparatus of (21), wherein the circuitry is configured to control the display to display a fourth hierarchical item in the menu structure that is a plurality of levels superior to the first hierarchical item in the menu structure as the second image data when the calculated value is less than the third threshold value.

(23) A non-transitory computer-readable medium including computer program instructions, which when executed by an information processing apparatus, cause the information processing apparatus to perform a process comprising: controlling a display to display first image data; acquiring a sensor output corresponding to a touch input received at the display; and controlling the display to display second image data based on a duration and distance corresponding to the touch input.

(24) A method performed by an information processing apparatus, the method comprising: controlling a display to display first image data; acquiring a sensor output corresponding to a touch input received at the display; and controlling, by circuitry of the information processing apparatus, the display to display second image data based on a duration and distance corresponding to the touch input.

(25) A display controlling apparatus, including:
a control section configured to carry out control for causing one of a first display screen image including a plurality of regions for accepting a user operation and a second display screen image for displaying one of the plurality of regions in an enlarged scale to be displayed; and
an operation acceptance section configured to accept a moving operation for moving the second display screen image displayed on a display face,
wherein, when the moving operation is accepted and satisfies a predetermined condition, the control section carries out control for causing the displayed region corresponding to the second display screen image and regions around the region to be displayed in a reduced scale.

(26) The display controlling apparatus according to (25) above, wherein the operation acceptance section detects at least one of a movement amount and an elapsed time period of the moving operation, and
the control section carries out, when at least one of the movement amount and the elapsed time period of the moving operation satisfies the predetermined condition, control for causing the region corresponding to the second display screen image and regions around the region to be displayed in a reduced scale.

(27) The display controlling apparatus according to (26) above, wherein the control section decides that the predetermined condition is satisfied when a value specified by at least one of the movement amount and the elapsed time period is higher than a threshold value.

(28) The display controlling apparatus according to (26) or (27) above, wherein the control section determines a reduction ratio upon the reduction display based on a magnitude of a value specified by at least one of the movement amount and the elapsed time period.

(29) The display controlling apparatus according to any one of (25) to (28) above, wherein, when the moving operation satisfies the predetermined condition, the control section carries out control for causing the second display screen image to be displayed after the lapse of a predetermined period of time after the reduction display is carried out.

(30) The display controlling apparatus according to any one of (25) to (29) above, wherein the control section carries out control for causing transition from the second display screen image to the reduction display to be displayed in the form of an animation.

(31) The display controlling apparatus according to (25) above, wherein, when the moving operation satisfies the predetermined condition, the control section carries out control for causing the first display screen image to be displayed.

(32) The display controlling apparatus according to any one of (25) to (31) above, wherein
the plurality of regions are displayed such that operation region images for accepting the user operation are displayed in a unit of a group, and
the operation acceptance section accepts the user operation on the operation region images only when the second display screen image is displayed on the display face.

(33) The display controlling apparatus according to any one of (25) to (32) above, wherein the operation acceptance section accepts a touching operation with the display face as the moving operation.

(34) A display controlling method, including:
a first controlling procedure for causing one of a first display screen image including a plurality of regions for accepting a user operation and a second display screen image for displaying one of the plurality of regions in an enlarged scale to be displayed; and
a second controlling procedure for causing, when a moving operation for moving the second display screen image displayed on a display face is accepted and the moving operation satisfies a predetermined condition, the displayed region corresponding to the second display screen image and regions around the region to be displayed in a reduced scale.

(35) A program for causing a computer to execute:
a first controlling procedure for causing one of a first display screen image including a plurality of regions for accepting a user operation and a second display screen image for displaying one of the plurality of regions in an enlarged scale to be displayed; and
a second controlling procedure for causing, when a moving operation for moving the second display screen image displayed on a display face is accepted and the moving operation satisfies a predetermined condition, the displayed region corresponding to the second display screen image and regions around the region to be displayed in a reduced scale.

### REFERENCE SIGNS LIST

100 Display controlling apparatus

101, 102 Speaker

110 Operation acceptance section

111 First button

112 Second button

113 Third button

114 Fourth button

115 Fifth button

120 Imaging section

121 Lens

130 Recording medium controlling section

140 Recording medium

150 Inputting/outputting section

151 Acceptance portion

152 Display portion

160 Inputting controlling section

170 Control section

171 Operation information retaining section

180 Display controlling section

1. An information processing apparatus comprising:
circuitry configured to control a display to display first image data;
acquire sensor output corresponding to a touch input received at the display; and
control the display to display second image data based on a duration and distance corresponding to the touch input.

2. The information processing apparatus of claim 1, wherein
the circuitry is configured to calculate a value corresponding to the duration and distance corresponding to the touch input.

3. The information processing apparatus of claim 2, wherein
the circuitry is configured to compare the calculated value to a predetermined threshold value.

4. The information processing apparatus of claim 3, wherein
the circuitry is configured to control the display to display the second image data based on the comparison.

5. The information processing apparatus of claim 2, wherein
the circuitry is configured to calculate the value by multiplying a first value corresponding to the duration of the touch input with a second value corresponding to the distance of the touch input.

6. The information processing apparatus of claim 5, wherein
the circuitry is configured to compare the calculated value to a first threshold value and control the display to display the first image data as the second image data when the calculated value is less than the first threshold value.

7. The information processing apparatus of claim 6, wherein
the circuitry compares the calculated value with a second threshold value when the calculated value is greater than or equal to the first threshold value.

8. The information processing apparatus of claim 7, wherein
the circuitry is configured to control the display to display image data neighboring the first image data as the second image data when the calculated value is less than the second threshold value.

9. The information processing apparatus of claim 7, wherein
the circuitry is configured to compare the calculated value with a third threshold value when the calculated value is greater than or equal to the second threshold value.

10. The information processing apparatus of claim 9, wherein
the circuitry is configured to control the display to display the first image data and first neighboring image data corresponding to a first area neighboring the first image data as the second image data when the calculated value is less than the third threshold value.

11. The information processing apparatus of claim 9, wherein
the circuitry is configured to control the display to display the first image data, first neighboring image data corresponding to a first area neighboring the first image data and second neighboring image data corresponding to a second area neighboring the first area as the second image data when the calculated value is greater than or equal to the third threshold value.

12. The information processing apparatus of claim 11, wherein
the first image data corresponds an item in a menu.

13. The information processing apparatus of claim 12, wherein
the first neighboring image data corresponds to items of the menu that neighbor the item displayed as the first image data.

14. The information processing apparatus of claim 13, wherein
the entire menu is displayed when the display is controlled to display the first image data, the first neighboring image data corresponding to the first area neighboring the first image data and second neighboring image data corresponding to a second area neighboring the first area.

15. The information processing apparatus of claim 1, wherein
the first image data corresponds to a first hierarchical item in a menu structure.

16. The information processing apparatus of claim 15, wherein
the second image data corresponds to a second hierarchical item in the menu structure that is at a different level of the menu structure than the first hierarchical item.

17. The information processing apparatus of claim 5, wherein
the first image data corresponds to a first hierarchical item in a menu structure, and
the circuitry is configured to compare the calculated value to a first threshold value and control the display to display the first hierarchical item as the second image data when the calculated value is less than the first threshold value.

18. The information processing apparatus of claim 17, wherein
the circuitry compares the calculated value with a second threshold value when the calculated value is greater than or equal to the first threshold value.

19. A non-transitory computer-readable medium including computer program instructions, which when executed by an information processing apparatus, cause the information processing apparatus to perform a process comprising:
controlling a display to display first image data;
acquiring a sensor output corresponding to a touch input received at the display; and
controlling the display to display second image data based on a duration and distance corresponding to the touch input.

20. A method performed by an information processing apparatus, the method comprising:
controlling a display to display first image data;
acquiring a sensor output corresponding to a touch input received at the display; and
controlling, by circuitry of the information processing apparatus, the display to display second image data based on a duration and distance corresponding to the touch input.
